(19) United States
(12) Patent Application Publication
(10) Pub. No.: US 2026/0208052 A1
(43) Pub. Date: Jul. 23, 2026

(54) NON-TRANSITORY COMPUTER READABLE MEDIUM, INFORMATION PROCESSING METHOD, AND INFORMATION PROCESSING SYSTEM

(71) Applicant: CYGAMES, INC., Tokyo (JP)

(72) Inventors: Satoru Okada, Tokyo (JP); Yuya Kato, Tokyo (JP); Makoto Kanai, Tokyo (JP); Tomonori Ezawa, Tokyo (JP); Yusuke Kashiro, Tokyo (JP)

(73) Assignee: CYGAMES, INC., Tokyo (JP)

(21) Appl. No.: 19/571,185

(22) Filed: Mar. 18, 2026

Related U.S. Application Data
(63) Continuation of application No. PCT/JP2024/032768, filed on Sep. 12, 2024.

(30) Foreign Application Priority Data
Sep. 28, 2023 (JP) 2023-168695

(51) Int. Cl. A63F 13/69; A63F 13/58; A63F 13/63; A63F 13/825

(52) U.S. Cl. CPC A63F 13/69; A63F 13/58; A63F 13/63; A63F 13/825

(57) ABSTRACT

Provided is a non-transitory computer readable medium storing a program causing a computer to execute processing of: determining a rank based on a predetermined parameter associated with game content owned by a player and storing the predetermined parameter corresponding to a predetermined rank as a reference value; enabling update of the predetermined parameter in accordance with a predetermined condition based on a player operation for the game content for which the predetermined parameter with respect to the reference value satisfies a specific condition; and enabling update of the predetermined parameter in accordance with an advantageous condition that is more advantageous to a player than the predetermined condition within a range up to the reference value based on a player operation for the game content, for which the predetermined parameter with respect to the reference value does not satisfy the specific condition.

### CROSS REFERENCE TO RELATED APPLICATIONS

This application is a continuation application of International Application No. PCT/JP2024/032768, filed on September 12, 2024, which claims priority to Japanese Patent Application No. 2023-168695, filed on September 28, 2023, the entire contents of which are incorporated by reference herein.

### BACKGROUND ART

### TECHNICAL FIELD

The present invention relates to an information processing program, an information processing method, and an information processing system.

For example, Patent Document 1 and Non-Patent Document 1 disclose a game in which the level of a character set in a frame by a player can be automatically raised to the same level as a character of a predetermined rank among characters manually nurtured by the player.

### Citation List

### Patent Literature

Patent Document 1: JP 7298766 B

### Non-Patent Literature

Non-Patent Document 1: NIKKE Method of Using Synchro Device, https://gamewith.jp/nikke/article/show/369927

### Summary of Invention

### Technical Problem

As described above, in the game of Patent Document 1 and Non-Patent Document 1, the level of only a portion of the characters set in the frame by the player, that is, the characters owned by the player can be raised. Thus, when the player tries to nurture many characters, the load becomes large, and there is a risk of the player becoming less motivated to play the game.

An object of the present invention is to provide an information processing program, an information processing method, and an information processing system that can reduce the player load and reduce the risk of the player becoming less motivated to play the game.

### Solution to Problem

To solve the above-mentioned problem, an information processing program causes a computer to execute processing of:

determining a rank based on a value of a predetermined parameter associated with game content owned by a player and storing the value of the predetermined parameter corresponding to a predetermined rank as a reference value;

enabling update of the value of the predetermined parameter in accordance with a predetermined condition based on a player operation for the game content, from among the game content owned by a player, for which the value of the predetermined parameter with respect to the reference value satisfies a specific condition; and

enabling update of the value of the predetermined parameter in accordance with an advantageous condition that is more advantageous to a player than the predetermined condition within a range up to the reference value based on a player operation for the game content, from among the game content owned by a player, for which the value of the predetermined parameter with respect to the reference value does not satisfy the specific condition.

The predetermined condition may include a consumable game content associated with a player being consumed, and

the advantageous condition may include the consumable game content associated with a player not being consumed.

A computer may be further caused to execute processing of:

determining a display mode of identification information corresponding to the game content owned by a player based on whether the value of the predetermined parameter with respect to the reference value satisfies the specific condition; and

displaying a list of the identification information on a display screen using the display mode determined.

The value of the predetermined parameter may be able to be further updated based on the predetermined condition for the game content with the value of the predetermined parameter in a state of having been updated to the reference value via the advantageous condition.

To solve the above-mentioned problem, an information processing method is an information processing method executed by a computer, the method comprising:

determining a rank based on a value of a predetermined parameter associated with game content owned by a player and storing the value of the predetermined parameter corresponding to a predetermined rank as a reference value;

enabling update of the value of the predetermined parameter in accordance with a predetermined condition based on a player operation for the game content, from among the game content owned by a player, for which the value of the predetermined parameter with respect to the reference value satisfies a specific condition; and

enabling update of the value of the predetermined parameter in accordance with an advantageous condition that is more advantageous to a player than the predetermined condition within a range up to the reference value based on a player operation for the game content, from among the game content owned by a player, for which the value of the predetermined parameter with respect to the reference value does not satisfy the specific condition.

To solve the above-mentioned problem, an information processing system is an information processing system provided with a computer, with the computer executing processing of:

determining a rank based on a value of a predetermined parameter associated with game content owned by a player and storing the value of the predetermined parameter corresponding to a predetermined rank as a reference value;

enabling update of the value of the predetermined parameter in accordance with a predetermined condition based on a player operation for the game content, from among the game content owned by a player, for which the value of the predetermined parameter with respect to the reference value satisfies a specific condition; and

enabling update of the value of the predetermined parameter in accordance with an advantageous condition that is more advantageous to a player than the predetermined condition within a range up to the reference value based on a player operation for the game content, from among the game content owned by a player, for which the value of the predetermined parameter with respect to the reference value does not satisfy the specific condition.

### Effects of Disclosure

According to the present invention, the player load can be reduced and the risk of the player becoming less motivated to play the game can be reduced.

### BRIEF DESCRIPTION OF DRAWINGS

FIG. 1 is an explanatory diagram illustrating a schematic configuration of an information processing system.

FIG. 2A is a diagram for describing a hardware configuration of a player terminal.

FIG. 2B is a diagram for describing a hardware configuration of a server.

FIG. 3A is a diagram for describing an example of a home screen.

FIG. 3B is a first diagram for describing an example of an ally character confirmation screen.

FIG. 3C is a first diagram for describing an example of an ally character detail screen.

FIG. 4A is a second diagram for describing an example of an ally character detail screen.

FIG. 4B is a third diagram for describing an example of an ally character detail screen.

FIG. 4C is a fourth diagram for describing an example of an ally character detail screen.

FIG. 5 is a fifth diagram for describing an example of an ally character detail screen.

FIG. 6A is a diagram for describing an example of a quest screen for a normal quest.

FIG. 6B is a diagram for describing an example of a quest selection screen for a normal quest.

FIG. 6C is a diagram for describing an example of a party selection screen.

FIG. 7A is a diagram for describing an example of a battle screen.

FIG. 7B is a diagram for describing an example of a result screen.

FIG. 7C is a diagram for describing an example of a report screen.

FIG. 8A is a diagram for describing a nurture ball ID database.

FIG. 8B is a diagram for describing an ally character database.

FIG. 9A is a second diagram for describing an example of an ally character confirmation screen.

FIG. 9B is a first diagram for describing an example of a synchro-function-usable ally character detail screen.

FIG. 10A is a diagram for describing an example of the rank-up confirmation pop-up.

FIG. 10B is a first diagram for describing an example of a free equipment completion pop-up.

FIG. 11A is a second diagram for describing an example of a synchro-function-usable ally character detail screen.

FIG. 11B is a first diagram for describing an example of a free enhance Lv completion pop-up.

FIG. 12A is a diagram for describing an example of a nurture ball list pop-up.

FIG. 12B is a diagram for describing an example of the rank-up confirmation pop-up.

FIG. 13A is a first diagram for describing an example of an ally character detail screen after the player has come to own a nurture ball.

FIG. 13B is a diagram for describing an example of the free equipment completion pop-up.

FIG. 14A is a second diagram for describing an example of an ally character detail screen after the player has come to own a nurture ball.

FIG. 14B is a diagram for describing an example of the free enhance Lv completion pop-up.

FIG. 15 is a diagram for describing an example of a batch enhance screen.

FIG. 16 is a diagram for describing a configuration of a memory in the player terminal and a function as a computer.

FIG. 17 is a diagram for describing a configuration of a memory in a server and a function as a computer.

FIG. 18 is a flowchart for describing synchro management processing in the server.

FIG. 19 is a flowchart for describing ally character detail screen processing in the player terminal.

FIG. 20 is a flowchart for describing parameter change processing in the server.

### DESCRIPTION OF EMBODIMENTS

Hereinafter, an aspect of an embodiment of the present invention will be described in detail with reference to the accompanying drawings. Dimensions, materials, specific numerical values, and the like described in the embodiment are merely examples for facilitating understanding and do not limit the present invention unless otherwise specified. In this description and the drawings, elements having substantially the same function and configuration are denoted by the same reference numerals, and redundant description thereof will be omitted, and elements not directly relating to the present invention will not be illustrated.

### Overall Configuration of Information Processing System S

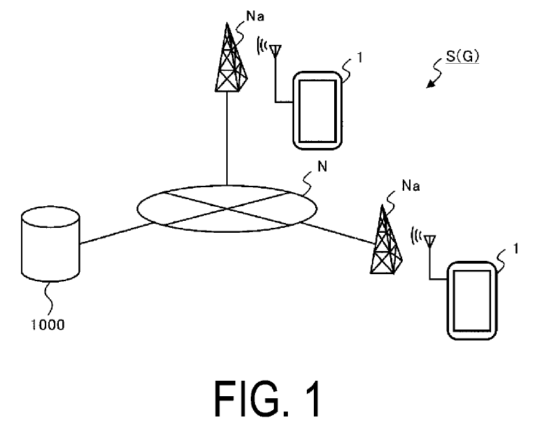

FIG. 1 is an explanatory diagram illustrating a schematic configuration of an information processing system S. The information processing system S is a so-called client-server system including a player terminal 1, a server 1000, and a communication network N including a communication base station Na.

The player terminal 1 can establish communication with the server 1000 via the communication network N. The player terminal 1 widely includes an electronic device capable of establishing a wireless or wired communication connection to the server 1000. Examples of the player terminal 1 include a smartphone, a mobile phone, a tablet device, a personal computer, or a game console. In the present embodiment, a case where a smartphone is used as the player terminal 1 will be described.

The server 1000 is communicatively connected to a plurality of player terminals 1. The server 1000 accumulates various types of information (player information) for each player ID for identifying a player who plays the game.

The communication base station Na is connected to the communication network N and wirelessly exchanges information with the player terminal 1. The communication network N is implemented as a cellular network, an Internet network, a local area network (LAN), a dedicated line, or the like, and establishes a wireless or wired communication connection between the player terminal 1 and the server 1000.

In the information processing system S of the present embodiment, the player terminal 1 and the server 1000 function as a game apparatus G. Each of the player terminal 1 and the server 1000 has a role of controlling the progress of the game, and the game can progress through cooperation between the player terminal 1 and the server 1000.

### Hardware Configurations of Player Terminal 1 and Server 1000

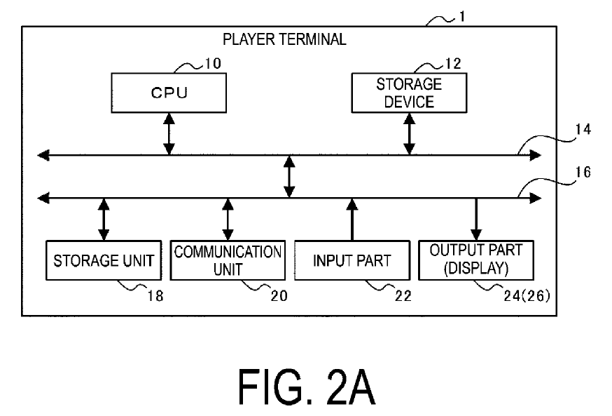

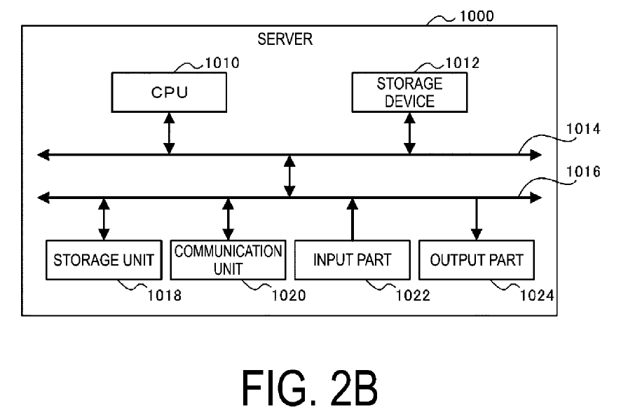

FIG. 2A is a diagram for describing a hardware configuration of the player terminal 1. FIG. 2B is a diagram for describing a hardware configuration of the server 1000. As illustrated in FIG. 2A, the player terminal 1 includes a central processing unit (CPU) 10, a storage device 12, a bus 14, an input/output interface 16, a storage unit 18, a communication unit 20, an input part 22, and an output part 24.

As illustrated in FIG. 2B, the server 1000 includes a CPU 1010, a storage device 1012, a bus 1014, an input/output interface 1016, a storage unit 1018, a communication unit 1020, an input part 1022, and an output part 1024.

The configurations and functions of the CPU 1010, the storage device 1012, the bus 1014, the input/output interface 1016, the storage unit 1018, the communication unit 1020, the input part 1022, and the output part 1024 of the server 1000 are substantially and respectively the same as the CPU 10, the storage device 12, the bus 14, the input/output interface 16, the storage unit 18, the communication unit 20, the input part 22, and the output part 24 of the player terminal 1. Thus, the hardware configuration of the player terminal 1 will be described below, but description of the server 1000 will be omitted.

The CPU 10 operates programs stored in the storage device 12 to control the progress of the game. The storage device 12 is implemented as a read only memory (ROM) or a random access memory (RAM) and stores programs and various types of data necessary for controlling the progress of the game. The storage device 12 is connected to the CPU 10 via the bus 14.

The input/output interface 16 is connected to the bus 14. The storage unit 18, the communication unit 20, the input part 22, and the output part 24 are connected to the input/output interface 16.

The storage unit 18 is implemented as a ROM or RAM and stores various types of programs and data. In the player terminal 1, the programs and data stored in the storage unit 18 are loaded into the storage device 12 by the CPU 10.

The communication unit 20 is wirelessly and communicatively connected to the communication base station Na and exchanges information such as various types of data and programs with the server 1000 via the communication network N. In the player terminal 1, programs or the like received from the server 1000 are stored in the storage device 12 or the storage unit 18.

The input part 22 is implemented as, for example, a touch panel, a button, a keyboard, a mouse, a four-direction key, an analog controller, and the like for inputting operations (receiving operations) of the player. Alternatively, the input part 22 may be a dedicated controller provided in the player terminal 1 or connected (externally attached) to the player terminal 1. Furthermore, the input part 22 may be implemented as an acceleration sensor that detects the inclination or movement of the player terminal 1 or a microphone that detects audio from the player. That is, the input part 22 widely includes apparatuses that allow the player to identifiably input their intention.

The output part 24 is implemented as a display apparatus and a speaker. Note that the output part 24 may be a device connected (externally attached) to the player terminal 1. In the present embodiment, the player terminal 1 includes a display 26 as the output part 24 and a touch panel layered over the display 26 as the input part 22.

### Details of Game

Next, details of a game provided by the information processing system S (game apparatus G) of the present embodiment will be described using an example. In the present embodiment, a so-called battle game is provided in which ally characters fight against enemy characters. Specifically, in the game of the present embodiment, a plurality of ally characters are provided. The player selects a plurality (5 in this example) of ally characters from among the provided ally characters to form a party. Also, various types of battle games with different enemy characters and different difficulty levels can be played by the player. The object of the battle game is for the ally characters in the party to obtain rewards by defeating (clearing) enemy characters.

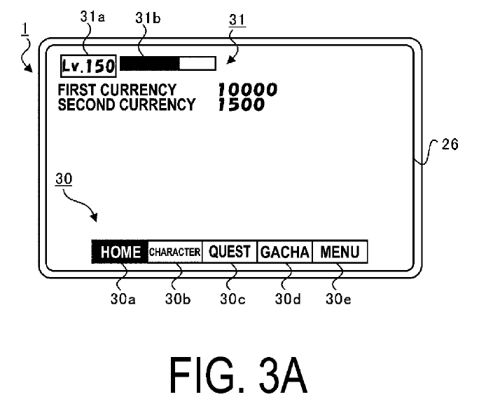

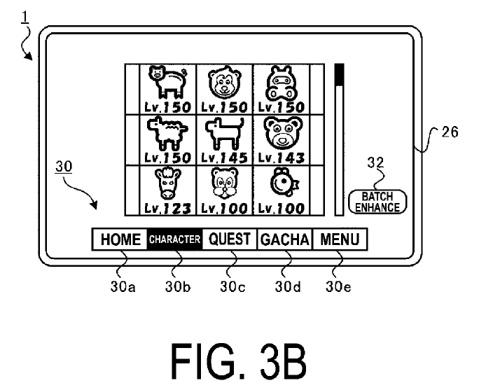

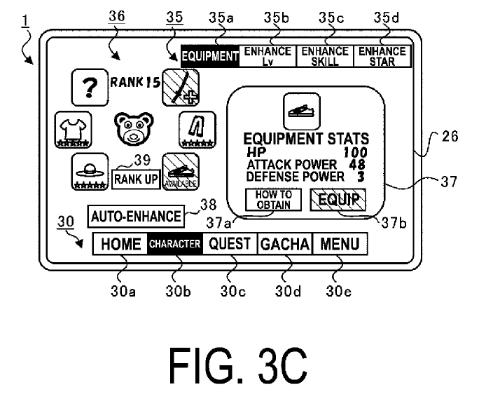

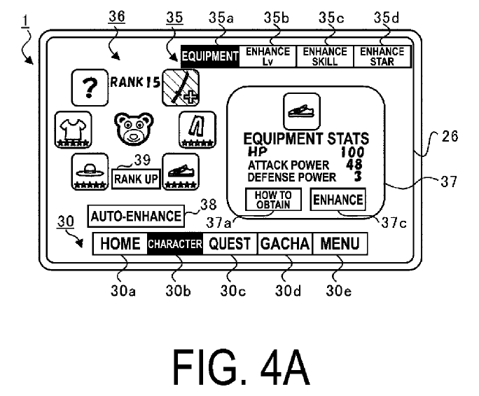

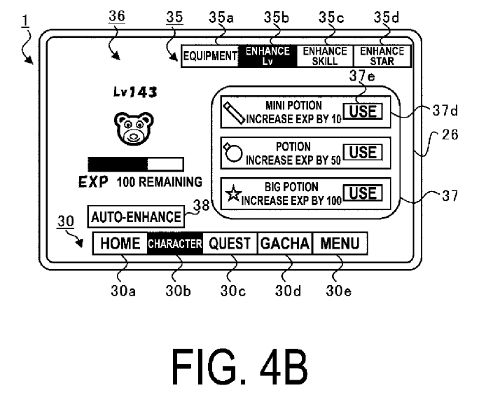

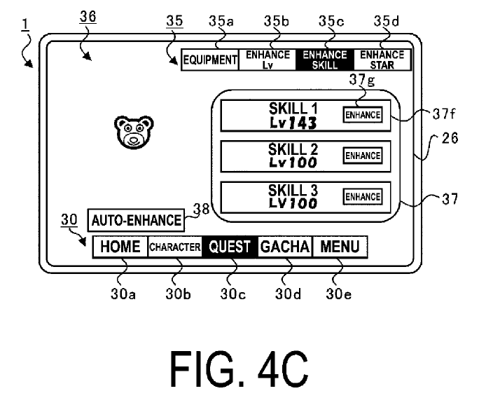

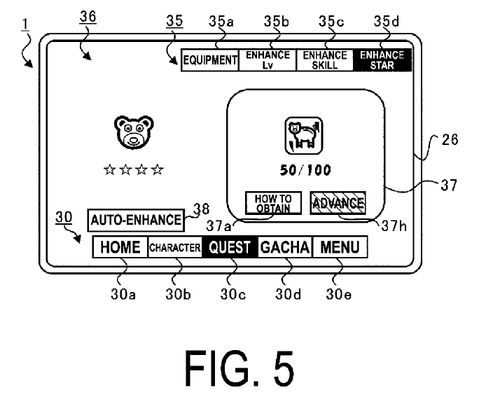

FIG. 3A is a diagram for describing an example of a home screen. FIG. 3B is a diagram for describing an example of an ally character confirmation screen. FIG. 3C is a first diagram for describing an example of an ally character detail screen. FIG. 4A is a second diagram for describing an example of an ally character detail screen. FIG. 4B is a third diagram for describing an example of an ally character detail screen. FIG. 4C is a fourth diagram for describing an example of an ally character detail screen. FIG. 5 is a fifth diagram for describing an example of an ally character detail screen. A game screen is displayed on the display 26 of the player terminal 1. In the present embodiment, the game screens are generally classified into normal screens and battle screens.

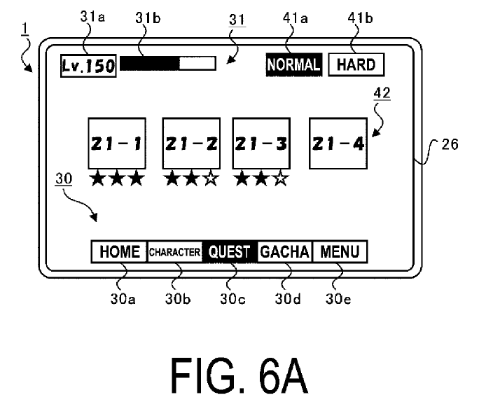

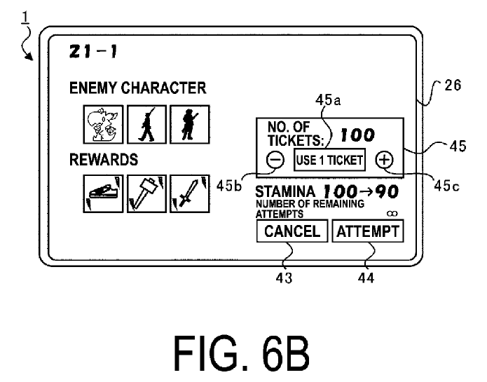

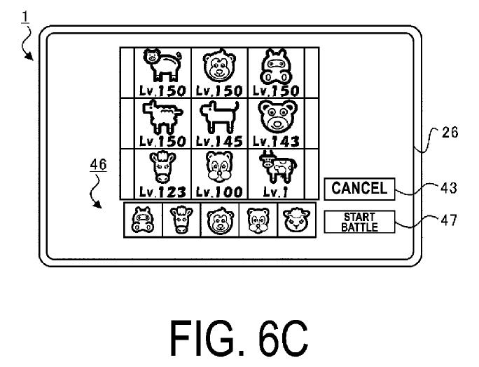

The normal screens are mainly screens on which a player makes various settings and confirms information. On the other hand, the battle screens are screens that are displayed on the display 26 from the start to the end of the battle game. Here, all the screens other than the battle screens are the normal screens. The normal screens include a plurality of screens such as a home screen illustrated in FIG. 3A, an ally character confirmation screen illustrated in FIG. 3B, a quest screen (see FIG. 6A), a shop screen (not illustrated), a guild screen (not illustrated), a gacha screen (not illustrated), a menu screen (not illustrated), and the like.

As illustrated in FIG. 3A, on the normal screen, a menu bar 30 is displayed at the bottom of the display 26. The menu bar 30 includes a plurality of operation portions that can be operated (tapped) by the player. The menu bar 30 is provided with a home screen selection operation portion 30a denoted by "HOME", an ally character confirmation screen selection operation portion 30b denoted by "CHARACTER", a quest screen selection operation portion 30c denoted by "QUEST", a gacha screen selection operation portion 30d denoted by "GACHA", and a menu screen selection operation portion 30e denoted by "MENU".

When the home screen selection operation portion 30a is tapped, the home screen illustrated in FIG. 3A is displayed on the display 26. When the ally character confirmation screen selection operation portion 30b is tapped, the ally character confirmation screen illustrated in FIG. 3B is displayed on the display 26. In a similar manner, when the quest screen selection operation portion 30c is tapped, the quest screen illustrated in FIG. 6A is displayed on the display 26. When the gacha screen selection operation portion 30d is tapped, a gacha screen (not illustrated) is displayed on the display 26. When the menu screen selection operation portion 30e is tapped, a menu screen is displayed on the display 26. Note that, though not described in detail, on the menu screen, game settings and various types of information can be checked.

In the menu bar 30, the selection operation portion corresponding to each screen is to be highlighted so that the screen being displayed on the display 26 can be identified.

The home screen illustrated in FIG. 3A corresponds to an initial screen, and a header display region 31 is provided at the upper left of the home screen. In the header display region 31, level information 31a indicating a player level associated with the player ID, a stamina display bar 31b indicating stamina of the player associated with the player ID, and owned amounts of a first currency and a second currency associated with the player ID are displayed.

The stamina is a parameter necessary to play the battle game. In the present embodiment, various types of battle games are provided, and a stamina consumption value required to play, number of attempts per day, and the like are set for each battle game. When a battle game in which the stamina consumption value necessary for play is set is played, a player consumes stamina to play the battle game. Thus, if the stamina is insufficient, the battle game cannot be played.

Although detailed description is omitted, when the player clears the battle game, the player can obtain a predetermined value as player experience. Each time the player experience reaches a certain value, the player level increases. The player level is set with a management upper limit value, and even if player experience is obtained, the player level does not increase beyond the set management upper limit value. The management upper limit value is set by the administrator and is increased at a predetermined timing.

Also, the player level is set with an upper limit value for stamina, and as the player level increases, the upper limit value for stamina also increases. Stamina is recovered by a predetermined value (for example, one point) at regular time intervals (for example, five minutes) within the range of the upper limit value. In the stamina display bar 31b, the current remaining amount of stamina is displayed so as to be visually recognizable with respect to the upper limit value of stamina.

The first currency and the second currency are currencies usable only in the game. For example, when a battle game is cleared, a predetermined amount of the first currency can be obtained according to the cleared battle game. The second currency can be obtained without charge or for a fee. The first currency and the second currency can be obtained by various methods, but a detailed description thereof will be omitted.

On the ally character confirmation screen illustrated in FIG. 3B, all images of the ally characters corresponding to the ally character IDs associated with the player ID are displayed. In other words, all the ally characters owned by the player are displayed on the ally character confirmation screen. The player can check all the ally characters by performing a slide operation on the ally character confirmation screen.

An ally character ID is for identifying an ally character, and a different ID is assigned to each ally character. When the player obtains a new ally character via, for example, a gacha lottery or the like, the ally character ID of the obtained ally character is associated with the player ID of the player.

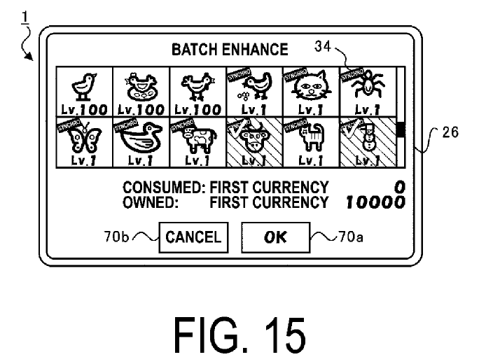

At the right end of the ally character confirmation screen, a batch enhance screen selection operation portion 32 denoted by "BATCH ENHANCE" is displayed. When the batch enhance screen selection operation portion 32 is tapped, the batch enhance screen illustrated in FIG. 15 described below is displayed on the display 26.

Various parameters such as stars (rarity), experience, character levels, skill levels, equipment ranks, and the like are stored in association with the ally characters. The experience increases when a player wins in a battle game described below or when a predetermined item is used. The character level is set corresponding to the experience, and the character level increases each time the experience reaches a predetermined value. The player level is set as the progress upper limit value of the character level. Thus, the character level can be raised up to the player level. In the present embodiment, the character level can be increased by consuming items such as in-game currency and experience materials owned by the player, that is, for a fee.

In addition, base values of the combat power of the ally character such as life points, attack power, and defense power are set for the ally character based on the stars (rarity) and the character level. The player can advantageously progress through the battle game as the combat power of the ally character increases. Each base value set for the ally character increases as the stars (rarity) increase and as the character level increases.

In addition, four skills to be executed (activated) in the battle game are set for each ally character. A skill level is set for each skill, and the higher the skill level, the greater the effect of the skill. Note that for the skill level, the character level is set as the progress upper limit value. Thus, the skill level can be raised up to the character level.

Also, it is possible to equip (set) the ally characters with equipment items such as weapons and armors. A character level at which each equipment item can be equipped is set for each equipment item. An additional value for attack power, defense power, and/or the like is set for each equipment item. When the equipment item is equipped to the ally character, the additional value of equipment item is added to the base values, and the combat power of the ally character can be enhanced.

Specifically, when an image of an ally character displayed on the ally character confirmation screen illustrated in FIG. 3B is tapped, as illustrated in FIG. 3C, an ally character detail screen corresponding to the tapped ally character is displayed on the display 26. The ally character detail screen is provided with an enhance item selection operation portion 35, an enhance item display region 36, an enhance details display region 37, and an auto-enhance operation portion 38.

The enhance item selection operation portion 35 is provided with a plurality of operation portions that can be operated (tapped) by the player. The enhance item selection operation portion 35 is provided with an equipment selection operation portion 35a, an enhance Lv selection operation portion 35b, an enhance skill selection operation portion 35c, and an enhance stars selection operation portion 35d. When any one operation portion of the enhance item selection operation portion 35 is selected, the selected operation portion is highlighted.

The enhance item display region 36 displays an enhance item corresponding to a selected operation portion of the enhance item selection operation portion 35.

When the equipment selection operation portion 35a of the enhance item selection operation portion 35 is tapped, six equipment items are displayed around the image of the ally character in the enhance item display region 36. Here, among the six equipment items, the equipment items that are not equipped by the ally character are displayed in gray as indicated by hatching in the diagram, and the equipment items that are equipped by the ally character are displayed in color.

In addition, among the equipment items that are not equipped by the ally character (the upper right equipment item and the lower right equipment item in the diagram), when the ally character already owns that equipment item (including a case where it can be created), a mark indicated by "+" is displayed as illustrated in the upper right equipment item in the diagram. On the other hand, when the user does not own that equipment item (including a case where it cannot be created), a display denoted by "AVAILABLE" is displayed as in the lower right equipment item in the diagram. In the diagram, an equipment item that has not yet been implemented into the game is indicated by "?" as with the upper left equipment item.

Further, an equipment rank (RANK 15 in the diagram) indicating the rank of the equipment item to be equipped is set for the ally character. The equipment rank can be raised when all (six) of the equipment items of the next lower rank are equipped. In a case where the rank can be raised, a rank-up operation portion 39 is enabled, and when the rank-up operation portion 39 is tapped, the equipment rank is raised by 1, and the equipment item of the raised equipment rank is displayed in the enhance item display region 36. That is, in the present embodiment, the equipment rank can be raised by consuming items such as various equipment items and in-game currency owned by the player, that is, for a fee.

When the equipment item in the enhance item display region 36 is tapped, the status of the operated equipment item is displayed in the enhance details display region 37. In the enhance details display region 37, an obtainment method operation portion 37a for displaying an obtainment method of the equipment item and an equipment operation portion 37b for equipping the equipment item are displayed. Although detailed description is omitted, when the obtainment method operation portion 37a is tapped, the obtainment method of the equipment item is displayed on the display 26. When the equipment operation portion 37b is tapped while the user owns the equipment item, the equipment item is installed.

When the equipment item is equipped, as illustrated in FIG. 4A, an enhance operation portion 37c is displayed in the enhance details display region 37 instead of the equipment operation portion 37b. Here, the equipment item can be enhanced up to five levels. Although detailed description is omitted, when the enhance operation portion 37c is tapped, a screen for selecting an item for enhancing the equipment item is displayed, and when an item is selected on the screen and a confirm operation portion (not illustrated) is tapped, the selected item is consumed and the equipment item is enhanced.

When the enhance Lv selection operation portion 35b of the enhance item selection operation portion 35 is tapped, as illustrated in FIG. 4B, the character level and the experience value until the character level is raised by 1 are displayed around the image of the ally character in the enhance item display region 36.

In addition, a plurality of item display portions 37d for increasing the experience are displayed in the enhance details display region 37. In the item display portion 37d, the name of the item, the description of the item, and a use operation portion 37e for using the item are displayed. When the use operation portion 37e is tapped, the experience of the ally character is increased by the experience corresponding to the item. When the player does not own the item displayed on the item display portion 37d, the use operation portion 37e of the item cannot receive an operation by the player.

When the enhance skill selection operation portion 35c of the enhance item selection operation portion 35 is tapped, as illustrated in FIG. 4C, an ally character image is displayed in the enhance item display region 36. In addition, a plurality of skill display portions 37f are displayed in the enhance details display region 37. In the skill display portion 37f, the name of the skill, the skill level, and an enhance operation portion 37g for increasing the skill level are displayed. When the enhance operation portion 37g is tapped, the first currency corresponding to the skill level is consumed, and the skill level is increased by one. When the player does not own the first currency corresponding to the skill level and when the skill level has reached the character level, the enhance operation portion 37g does not accept an operation by the player.

When the enhance stars selection operation portion 35d of the enhance item selection operation portion 35 is tapped, as illustrated in FIG. 5, an ally character image and the stars (rarity) of the ally character are displayed in the enhance item display region 36. In addition, items necessary for raising (increasing) the stars are displayed in the enhance details display region 37. In the enhance details display region 37, the number of items owned by the player with respect to the number of items necessary for raising the stars (necessary number) is displayed as, for example, 50/100.

In the enhance details display region 37, the obtainment method operation portion 37a for displaying an obtainment method of the item and an advance operation portion 37h for raising the stars are provided. When the obtainment method operation portion 37a is operated, the obtainment method of the item is displayed on the display 26. When the number of items owned by the player satisfies the necessary number and the advance operation portion 37h is tapped, the stars of the ally character are increased by one. When the number of items for raising the stars is less than the necessary number, the advance operation portion 37h is displayed in gray as indicated by hatching in FIG. 5 and an operation by the player is not accepted.

When the auto-enhance operation portion 38 of the ally character detail screen is tapped, the character level, the skill level, and the equipment rank of the ally character are increased as much as possible.

FIG. 6A is a diagram for describing an example of a quest screen for a normal quest. FIG. 6B is a diagram for describing an example of a quest selection screen for a normal quest. FIG. 6C is a diagram for describing an example of a party selection screen.

On the home screen illustrated in FIG. 3A, when the quest screen selection operation portion 30c is tapped, the quest screen illustrated in FIG. 6A is displayed on the display 26. In the present embodiment, two types of battle games, namely, a normal quest and a hard quest, are described as examples, but battle games of other types (guild battle and the like) may be provided.

Depending on the battle game type, an unlock condition may be set. Examples of unlock conditions include the player level being equal to or greater than a predetermined value or another predetermined battle game being cleared. In addition, each battle game type includes a plurality of battle games (stages). An unlock condition is set for each of these battle games. When the unlock condition is satisfied, game unlock information included in the player information is updated.

The quest screen is provided with a normal quest selection operation portion 41a for selecting a normal quest and a hard quest selection operation portion 41b for selecting a hard quest. In the quest screen, either the normal quest selection operation portion 41a or the hard quest selection operation portion 41b is always in a selected state, and the normal quest selection operation portion 41a is selected as an initial state. Hereinafter, a case where the normal quest selection operation portion 41a is selected will be described, but the same applies to a case where the hard quest selection operation portion 41b is selected.

When the normal quest selection operation portion 41a is selected, a quest operation portion 42 for selecting any of a plurality of battle games (stages) belonging to the normal quest is displayed on the quest screen.

Clear information of each battle game is also displayed in the quest operation portion 42. The clear information is indicated using three stars, for example. In a battle game, when the battle game is cleared, stars are obtained in accordance with the number of ally characters whose life points are 0 when the battle game is cleared. For example, when there are no ally characters with 0 life points, three stars are obtained. When there is one ally character with 0 life points, two stars are obtained. When there are two or more ally characters with 0 life points, one star is obtained.

In the example of FIG. 6A, three stars have been obtained in the battle game "21-1", two stars have been obtained in the battle game "21-2", and two stars have been obtained in the battle game "21-3". In addition, for the battle game "21-4", no stars have been obtained, notifying that the battle game has not been cleared.

For a quest (normal quests and hard quests), clearing of the previous battle game is set as an unlock condition. For example, in the example of FIG. 6A, the battle game "21-3" is cleared, unlocking the battle game "21-4", but the subsequent battle games ("21-5" and subsequent battle games (not illustrated)) are not unlocked.

In the quest screen, for example, when the quest operation portion 42 of the battle game "21-1" is operated (tapped), the quest selection screen illustrated in FIG. 6B is displayed on the display 26. On the quest selection screen, an enemy character appearing in the battle game and an item (reward) obtainable in the battle game are displayed. In addition, the quest selection screen displays stamina before and after the execution of the battle game and the number of remaining attempts. The number of remaining attempts indicates the number of times an attempt can be made in one day, and this is set to infinite for the battle game of a normal quest. In the present embodiment, the stamina consumed in the battle game of a normal quest is set to 10. However, the stamina consumed in the battle game of a normal quest may be different for each battle game.

In addition, a cancel operation portion 43 and an attempt operation portion 44 denoted by "ATTEMPT" for attempting the battle game are displayed on the quest selection screen.

When the cancel operation portion 43 is operated (tapped), the quest screen illustrated in FIG. 6A is displayed on the display 26 and the attempt of the selected battle game "21-1" is canceled.

On the other hand, when the attempt operation portion 44 is operated (tapped), the party selection screen illustrated in FIG. 6C is displayed on the display 26. All ally characters owned by the player are displayed in the party selection screen. Below the party selection screen, a selected ally character display region 46 for displaying the selected ally characters is displayed.

In addition, on the party selection screen, the cancel operation portion 43 and a battle start operation portion 47 denoted by "START BATTLE" are displayed.

When the player operates (taps) the displayed ally character on the party selection screen, the operated ally character is displayed in the selected ally character display region 46. That is, here, an ally character ID to be used in the battle game (to determine a party) is selected from among a plurality of ally character IDs associated with the player ID.

Then, when an ally character (ally character ID) is selected and the battle start operation portion 47 is operated (tapped), the battle game is started.

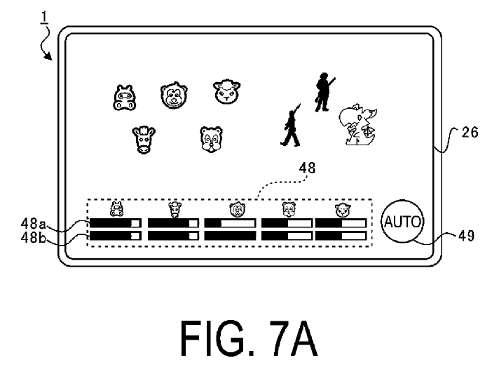

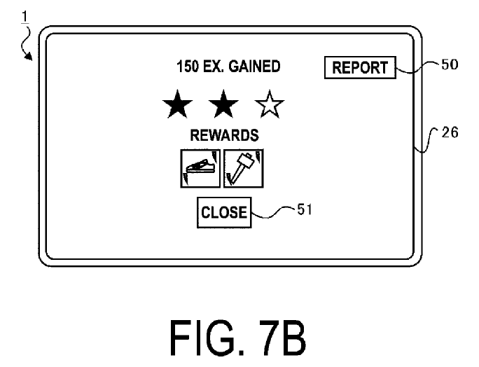

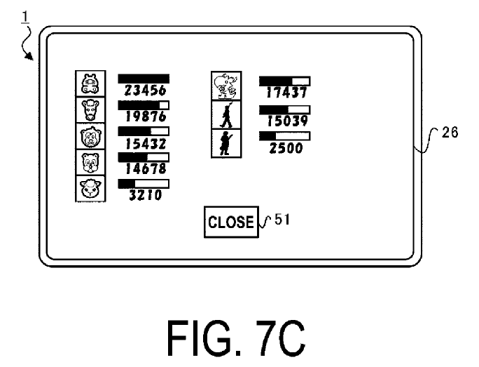

FIG. 7A is a diagram for describing an example of a battle screen. FIG. 7B is a diagram for describing an example of a result screen. FIG. 7C is a diagram for describing an example of a report screen. Then, when the battle start operation portion 47 is operated (tapped) on the party selection screen illustrated in FIG. 6C, the battle game is started.

During the battle game, as illustrated in FIG. 7A, the battle screen is displayed. In the battle screen, the ally character and the enemy character are displayed on the display 26. The ally characters are operated under computer control to damage the enemy character and receive damage from the enemy character. The enemy character operates under computer control to damage the ally characters or receive damage from the ally characters.

When damage points are given to the enemy character, the damage points are subtracted from the life points of the enemy character. Similarly, when damage points are given to the ally character, the damage points are subtracted from the life points of the ally character. When the life points of all the enemy characters become 0, the player wins (clears), and when the life points of all the ally characters become 0 (loses), the player loses.

Here, at a lower portion of the battle screen, as illustrated in FIG. 7A, an ally character display region 48 is provided. In the ally character display region 48, life points 48a and a skill gauge 48b for each ally character are displayed. The skill gauge 48b rises when the ally character receives damage from the enemy character and when the ally character causes damage to the enemy character. When the skill gauge 48b reaches a predetermined maximum value, the ally character can use a skill. With the skill, the damage points given to the enemy character are larger than that of a normal attack, life points of the ally character are recovered, or a special effect is given to the enemy character.

Here, two patterns are provided for a method of using the skill. One is a method in which the player operates (taps) the ally character displayed in the ally character display region 48 with the skill gauge 48b at a maximum value. The other is a method in which the ally character uses the skill under computer control when the skill gauge 48b reaches the maximum value in an automatic state. An automatic selection operation portion 49 is displayed on the battle screen, and the player can switch between the automatic state and a manual state by operating the automatic selection operation portion 49. When the automatic selection operation portion 49 is operated in the manual state, the automatic state in which the skill is automatically used is set. In addition, when the automatic selection operation portion 49 is operated in the automatic state, the manual state in which the skill is manually used is set. Even in the automatic state, when the player operates (taps) the ally character in a state where the skill gauge 48b has reached the maximum value and the skill has not been used by computer control, the skill can be used.

When the battle game ends normally (normal end), the result screen is displayed on the display 26 as illustrated in FIG. 7B. As an example, FIG. 7B illustrates a result screen for when the battle game is cleared.

At least a portion of game result information of the battle game is displayed on the result screen. Further, a report display operation portion 50 denoted by "REPORT" and an end operation portion 51 denoted by "CLOSE" are displayed on the result screen.

The game result information includes an ally character ID (party) of the ally character, an enemy character ID of the enemy character, remaining status of the ally characters and the enemy character at the end of the battle (whether the life points are 0 at the end of the battle game), damage points dealt (total value), manual state or automatic state, a battle log ID, battle game type (normal quest, hard quest, or the like), information associated with each type of battle game (clear information, battle game stage, and the like), the given item information, given first currency, and the like. Further, the battle log ID is uniquely assigned to each battle game. The information associated with each type of the battle game has different content for each type of the battle game. When the battle game is cleared, the server 1000 determines whether or not to give each item set in advance for the cleared battle game to the player by lottery. Then, the item to be given to the player is provided in the game result information and displayed on the result screen.

When the end operation portion 51 is operated (tapped) on the result screen, the display of the display 26 is switched from the battle screen to the normal screen. That is, the result screen is a part of the battle screen. The normal screen switched from the result screen may be the screen displayed immediately before switching to the battle screen, or may be a predetermined screen such as a home screen. In this manner, the battle game is ended in conjunction with the end of the display of the result screen.

When the report display operation portion 50 is operated (tapped) on the result screen, the report screen illustrated in FIG. 7C is displayed on the display 26. The report screen displays the damage points (total value) given by the ally character and the enemy character. The report screen also displays the end operation portion 51.

When the end operation portion 51 is operated (tapped), the result screen illustrated in FIG. 7B is displayed on the display 26.

In addition, a ticket display region 45 is provided on the quest selection screen illustrated in FIG. 6B. The ticket display region 45 displays the number of tickets owned by the player (the number of tickets associated with the player ID). The ticket display region 45 includes a ticket use attempt operation portion 45a, a minus operation portion 45b, and a plus operation portion 45c. The ticket use attempt operation portion 45a, the minus operation portion 45b, and the plus operation portion 45c are enabled only in a battle game in which three stars are obtained as clear information and cannot be operated in a battle game in which three stars are not obtained as clear information.

In a case where the ticket use attempt operation portion 45a, the minus operation portion 45b, and the plus operation portion 45c are enabled, each time the plus operation portion 45c is operated (tapped), the text in the ticket use attempt operation portion 45a is displayed so as to display an increase of one such as "use two tickets" or "use three tickets". In addition, each time the minus operation portion 45b is operated (tapped), the text in the ticket use attempt operation portion 45a is displayed so as to display a reduction of one such as "use two tickets" or "use one ticket".

Then, for example, in a case where the text written on the ticket use attempt operation portion 45a is "use 5 tickets", when the ticket use attempt operation portion 45a is operated (tapped), 5 tickets and 50 stamina are consumed, the creation of the party on the party selection screen illustrated in FIG. 6C and the execution of the battle game on the battle screen illustrated in FIG. 7A are omitted (skipped), all (here, five) battle games are regarded as being cleared, and a result screen such as that illustrated in FIG. 7B is displayed. On the result screen, the items obtained in the five battle games are collectively displayed.

In this manner, by spending the tickets, the battle game in which three stars are obtained as the clear information is omitted, and the battle game is treated as being cleared. As a result, the player can collect items in a shorter amount of time.

In the present embodiment, when a predetermined condition is satisfied, the parameter of the ally character (game object) can be changed to a specified value without charge. The predetermined condition is, for example, a case where a synchro function described later in detail is used, or a case where a nurture ball (game item) is used as an item.

In the present embodiment, the synchro function is roughly divided into a first synchro function and a second synchro function. Specifically, the first synchro function is a function that enables the character level and the skill level of the ally character to be raised (changed) to the synchro level (reference value) without charge. With the first synchro function, the rank is determined based on the value of the character level of the ally character owned by the player, and the value of the character level corresponding to a predetermined rank (in the present embodiment, the top 30) is set.

The second synchro function is a function that enables the equipment rank of the ally character to be raised (changed) to the synchro rank (reference value) without charge. Specifically, the second synchro function is a function that enables the equipment rank of the ally character to be raised (changed) to the synchro rank without charge. With the second synchro function, the rank is determined based on the value of the equipment rank of the ally character owned by the player, and the value of the synchro rank corresponding to a predetermined rank (in the present embodiment, the top 30) is set.

In the game of the present embodiment, a nurture ball is provided as an item. The nurture balls can be obtained by the player by, for example, the nurture balls being distributed from the administrator, the player clearing a predetermined battle game, the player clearing a predetermined event, and the like.

By consuming a nurture ball, the nurture ball function can be used. When the nurture ball function is used, it is possible to raise (change), for example, the character level, the skill level, and the equipment rank, from among the parameters of the ally character, without charge. As will be described in detail later, a nurture ball ID is set in advance for each nurture ball, and the character level, the skill level, and the equipment rank can be increased to a level/rank based on the set nurture ball ID without charge. Note that, in order to use the nurture ball function, it is necessary to consume (use) a nurture ball, but after the nurture ball is consumed, it is possible to raise the character level to a predetermined level without consuming items such as in-game currency and experience materials owned by the player. Similarly, after the nurture ball is consumed, the character level can be raised to a predetermined level without consuming items such as various equipment items and in-game currency owned by the player.

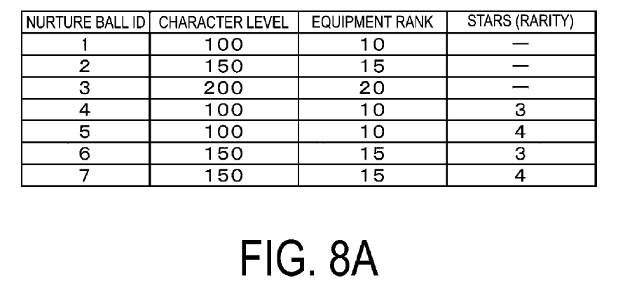

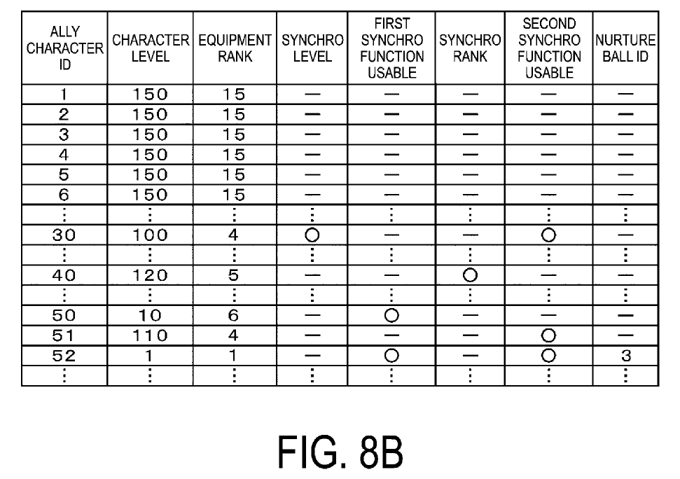

FIG. 8A is a diagram for describing a nurture ball ID database. The nurture ball ID database illustrated in FIG. 8A is stored in the player terminal 1 and the server 1000. In the nurture ball ID database, a value (specified value) of a parameter that can be raised free of charge is set for each nurture ball ID. The nurture balls are given to the player in a state where any one of the nurture ball IDs is associated with the player.

For example, when the nurture ball ID is 1, the character level (skill level) can be raised to 100 and the equipment rank can be raised to 10 without charge.

FIG. 8B is a diagram for describing an ally character database. The ally character database illustrated in FIG. 8B is stored in the player terminal 1 and the server 1000. The ally character database stores various types of information associated with ally characters owned by the player in association with the player ID.

Specifically, the ally character database stores, for each ally character ID of the ally character owned by the player, values of various parameters, information on whether or not to use a reference value of the synchro level, information on whether or not to use a reference value of the synchro rank, information on whether or not the first synchro function is usable, information on whether or not the second synchro function is usable, and a nurture ball ID in a case where the nurture ball ID is associated with the ally character.

In the case illustrated in FIG. 8B, the value (100) of the character level corresponding to the top 30 is set as the synchro level. In the case illustrated in FIG. 8B, the character level of the ally character with "30" for the value of the ally character ID is 100, and information as a reference value of the synchro level is associated with the ally character. When there are a plurality of ally characters having the values of the character levels corresponding to the top 30, information as a reference value of the synchro level is associated with the ally character having the smallest value for the character ID.

In the case illustrated in FIG. 8B, the value (5) of the equipment rank corresponding to the top 30 is set as the synchro rank. In the case illustrated in FIG. 8B, the equipment rank of the ally character with "40" for the value of the ally character ID is 5, and information as a reference value of the synchro rank is associated with the ally character. When there are a plurality of ally characters having the values of the equipment rank corresponding to the top 30, information as a reference value of the synchro rank is associated with the ally character having the smallest value for the character ID.

Further, information indicating that the first synchro function is usable is associated with the ally character ID of the ally character whose character level is lower than the synchro level. When the character level of the ally character is raised to the synchro level without charge by using the first synchro function, the information indicating that the first synchro function associated with the ally character ID is usable is deleted.

Further, information indicating that the second synchro function is usable is associated with the ally character ID of the ally character whose equipment rank is lower than the synchro rank. When the equipment rank of the ally character is raised to the synchro rank without charge by using the second synchro function, the information indicating that the second synchro function associated with the ally character ID is usable is deleted.

Even when the character level of the ally character is raised to the synchro level without charge by using the first synchro function, the second synchro function can then be used if the equipment rank of the ally character is still lower than the synchro rank. Thus, in this case, the information indicating that the second synchro function associated with the ally character ID is usable is not deleted.

Even when the equipment rank of the ally character is raised to the synchro rank without charge by using the second synchro function, the first synchro function can then be used if the character level of the ally character is still lower than the synchro level. Thus, in this case, the information indicating that the first synchro function associated with the ally character ID is usable is not deleted.

As illustrated in FIG. 8B, when a nurture ball is used for an ally character of an ally character owned by the player, a nurture ball ID is stored in association with an ally character ID. In the present embodiment, when both the information indicating that the first synchro function or the second synchro function is usable and the nurture ball ID are associated with the ally character ID, the player may select any function to use. However, when both the information indicating that the first synchro function or the second synchro function is usable and the nurture ball ID are associated with the ally character ID, the nurture ball function may be able to be preferentially used. Also, when both the information indicating that the first synchro function or the second synchro function is usable and the nurture ball ID are associated with the ally character ID, the first synchro function or the second synchro function may be able to be preferentially used. Alternatively, when both the information indicating that the first synchro function or the second synchro function is usable and the nurture ball ID are associated with the ally character ID, the function with the higher value for a parameter (character level or equipment rank) that can be raised without charge may be able to be preferentially used.

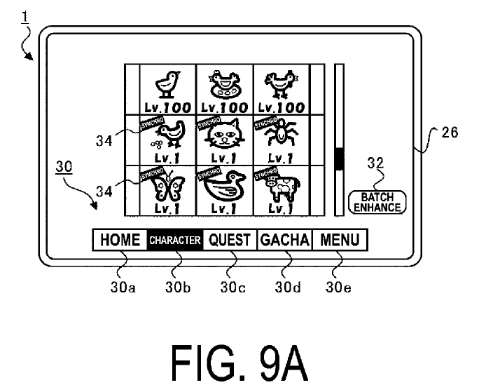

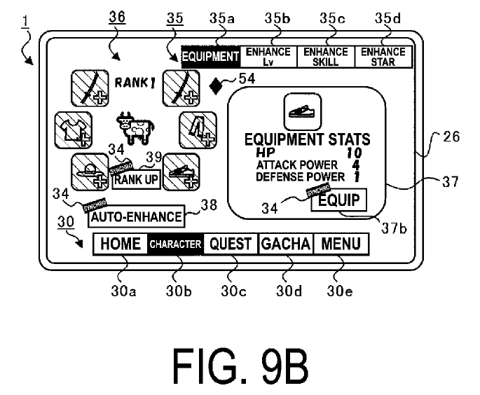

FIG. 9A is a second diagram for describing an example of an ally character confirmation screen. FIG. 9B is a first diagram for describing an example of a synchro-function-usable ally character detail screen. In the ally character database, when information indicating that the first synchro function or the second synchro function is usable is associated with the ally character ID, a synchro band 34 denoted by "SYNCHRO" is displayed superimposed on the image of the ally character corresponding to the ally character ID, as illustrated in FIG. 9A. Thus, that the synchro function is usable for the ally character on which the synchro band 34 is displayed is notified.

In FIG. 9A, when an image of an ally character displaying the synchro band 34 is tapped, as illustrated in FIG. 9B, an ally character detail screen corresponding to the tapped ally character is displayed on the display 26. In this case, as illustrated in FIG. 9B, the obtainment method operation portion 37a is not displayed in the enhance details display region 37. The synchro band 34 is displayed superimposed on the equipment operation portion 37b. Further, the synchro band 34 is also displayed superimposed on the auto-enhance operation portion 38 and the rank-up operation portion 39.

When the player owns a nurture ball and a predetermined use condition is satisfied, a nurture ball icon 54 functioning as an operation portion is centrally displayed on the ally character detail screen as illustrated in FIG. 9B. The use condition is, for example, that the normal quest "2-5" is cleared and other nurture balls have not been used for the ally character or the like.

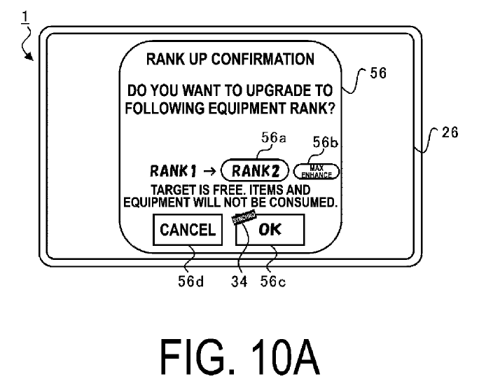

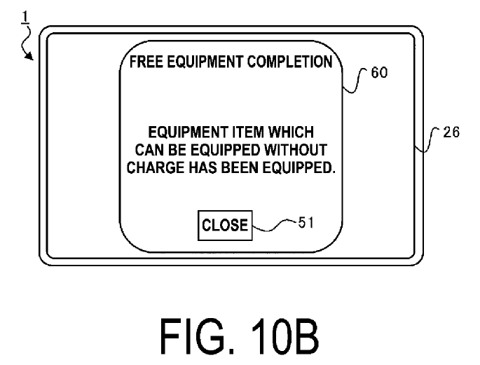

FIG. 10A is a diagram for describing an example of the rank-up confirmation pop-up. When the rank-up operation portion 39 on which the synchro band 34 is displayed as in FIG. 9B is tapped, a rank-up confirmation pop-up 56 illustrated in FIG. 10A is displayed on the display 26.

The rank-up confirmation pop-up 56 is provided with a pull-down type equipment rank selection operation portion 56a for selecting which equipment rank to set. The player operates the equipment rank selection operation portion 56a to select a desired equipment rank. In the equipment rank selection operation portion 56a, the selectable equipment ranks up to the synchro rank are displayed in a pull-down menu as candidates. As illustrated in FIG. 10A, the rank-up confirmation pop-up 56 is provided with a maximum enhance operation portion 56b denoted by "MAX ENHANCE". When the maximum enhance operation portion 56b is tapped, the synchro rank is automatically selected in the equipment rank selection operation portion 56a.

As illustrated in FIG. 10A, a confirm operation portion 56c and a cancel operation portion 56d are displayed in the rank-up confirmation pop-up 56. As illustrated in FIG. 10A, the synchro band 34 is displayed superimposed on the confirm operation portion 56c.

When the cancel operation portion 56d is tapped, the rank-up confirmation pop-up 56 is hidden. On the other hand, when the confirm operation portion 56c is tapped, the second synchro function is used, and the equipment rank of the ally character is raised to the equipment rank selected in the equipment rank selection operation portion 56a without charge. Specifically, for example, when the equipment rank selected in the equipment rank selection operation portion 56a is "2", the equipment rank is raised to "2" (all "RANK 1" equipment items are treated as being equipped). At this time, the character level is raised to 3, which is necessary for equipping all of the "RANK 1" equipment items.

When the equipment rank becomes the synchro rank and all of the equipment items with the synchro rank are equipped without charge, a free equipment completion pop-up 60 is displayed on the display 26 as illustrated in FIG. 10B. The free equipment completion pop-up 60 displays a text notifying the player that all of the equipable equipment items have been equipped without charge. In the present embodiment, the equipment rank of the ally character whose equipment rank has been raised to the synchro rank by using the synchro function can be further raised for a fee, that is, by consuming items such as various equipment items and in-game currency owned by the player. In the present embodiment, when the equipment rank of the ally character is raised using the second synchro function, the equipment rank of the ally character cannot thereafter be returned to the equipment rank of before the use of the second synchro function. However, when the equipment rank of the ally character is raised using the second synchro function, the equipment rank of the ally character may be able to be returned to the equipment rank of before the use of the second synchro function.

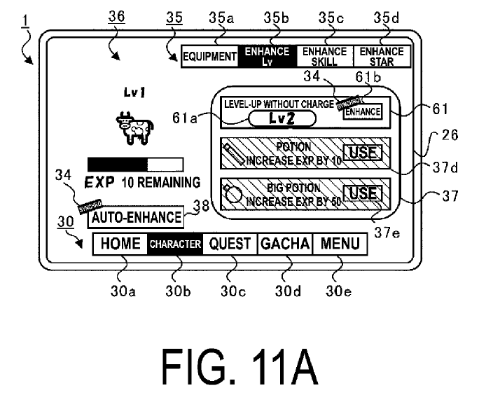

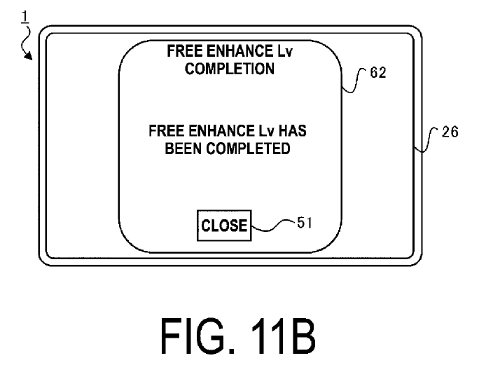

FIG. 11A is a second diagram for describing an example of a synchro-function-usable ally character detail screen. FIG. 11B is a first diagram for describing an example of a free equipment completion pop-up. When the enhance Lv selection operation portion 35b is tapped on the ally character detail screen illustrated in FIG. 9B, the ally character detail screen illustrated in FIG. 11A is displayed on the display 26. In this case, as illustrated in FIG. 11A, a free level-up display portion 61 is displayed above the item display portion 37d in the enhance details display region 37. The free level-up display portion 61 is provided with a pull-down type level selection operation portion 61a for selecting how much to raise the character level and an enhance operation portion 61b where the synchro band 34 is displayed in a superimposed manner. The player operates the level selection operation portion 61a to select a desired character level. In the level selection operation portion 61a, the selectable character levels up to the synchro level are displayed in a pull-down menu as candidates.

Then, when the enhance operation portion 61b is tapped, the character level is raised to the character level displayed in the level selection operation portion 61a. Thereafter, when the character level becomes the synchro level, a free enhance Lv completion pop-up 62 is displayed on the display 26 as illustrated in FIG. 11B. The free enhance Lv completion pop-up 62 displays a text notifying the player of the completion of raising the character level to the level that can be increased without charge. Until the character level of the ally character has been raised to the level that can be increased without charge, the use operation portion 37e of the item display portions 37d does not accept an operation by the player as indicated by hatching in the diagram. In the present embodiment, the character level of the ally character whose character level has been raised to the synchro level by using the synchro function can be further raised by paying a fee, that is, by consuming an item such as in-game currency or experience material owned by the player.

Note that the skill level can be raised to the same level as the character level without charge by using the first synchro function, but the way of raising the skill level is the same as that for the character level, and therefore, the description thereof is omitted.

When the auto-enhance operation portion 38 on which the synchro band 34 is superimposed is tapped, the character level and the skill level of the ally character are raised to the synchro level. The equipment rank of the ally character is raised to the synchro rank. In other words, when the auto-enhance operation portion 38 on which the synchro band 34 is superimposed is tapped, the character level, the skill level, and the equipment rank of the ally character are raised as high as they can be increased without charge.

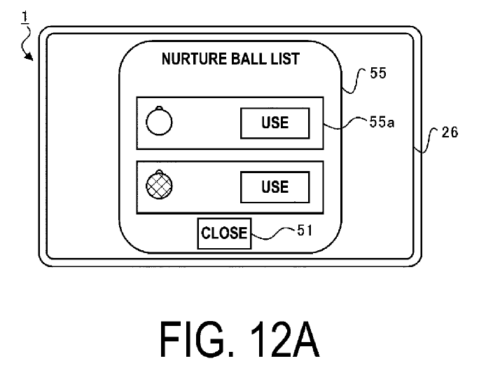

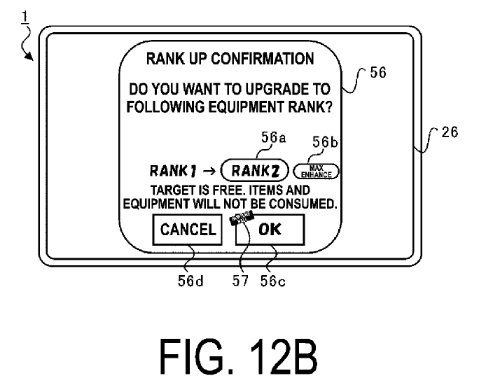

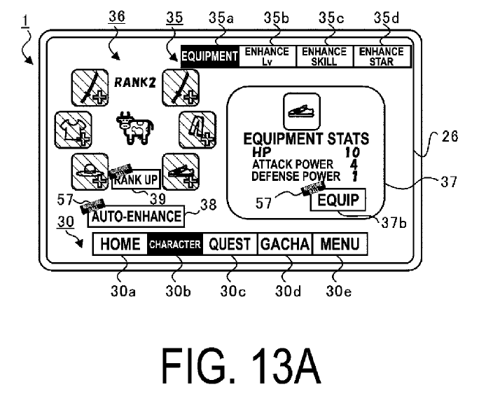

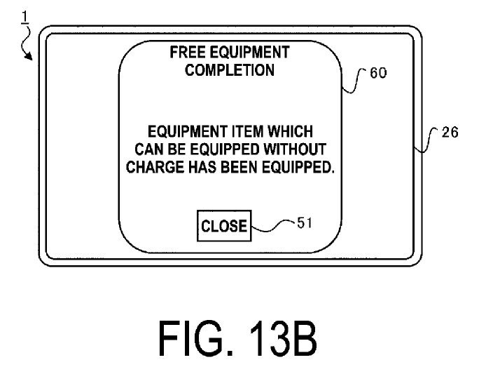

FIG. 12A is a diagram for describing an example of a nurture ball list pop-up 55. FIG. 12B is a diagram for describing an example of the rank-up confirmation pop-up 56. FIG. 13A is a first diagram for describing an example of an ally character detail screen after the player has come to own a nurture ball. FIG. 13B is a diagram for describing an example of the free equipment completion pop-up 60.

When the player owns a nurture ball and a predetermined use condition is satisfied, a nurture ball icon 54 functioning as an operation portion is centrally displayed on the ally character detail screen as illustrated in FIG. 9B. The use condition is, for example, that the normal quest "2-5" is cleared and other nurture balls have not been used for the ally character or the like.

When the nurture ball icon 54 is tapped, the nurture ball list pop-up 55 illustrated in FIG. 12A is displayed on the display 26. The nurture ball list pop-up 55 displays images of nurture balls owned by the player and a use operation portion 55a for using each nurture ball. When the image of the nurture ball is long-pressed, the character level and the equipment rank that can be raised without charge by the nurture ball are displayed on the display 26. In addition, the end operation portion 51 is displayed in the nurture ball list pop-up 55, and when the end operation portion 51 is tapped, the nurture ball list pop-up 55 is hidden.

When the use operation portion 55a corresponding to the usable nurture ball is operated, the rank-up confirmation pop-up 56 illustrated in FIG. 12B is displayed on the display 26. In the example described below, the character level of the ally character is 1, the equipment rank is 1, and the equipment rank can be raised to 10 and the character level can be raised to 100 without charge when the nurture ball is used.

The rank-up confirmation pop-up 56 illustrated in FIG. 12B is different from the rank-up confirmation pop-up 56 illustrated in FIG. 10A in that a nurture ball band 57 denoted by "NURTURE BALL" is displayed superimposed on the confirm operation portion 56c.

When the cancel operation portion 56d is tapped on the rank-up confirmation pop-up 56 illustrated in FIG. 12B, use of the nurture ball is cancelled, and the rank-up confirmation pop-up 56 is hidden. Further, in the rank-up confirmation pop-up 56 illustrated in FIG. 12B, when the confirm operation portion 56c is tapped, the nurture ball is used, and the equipment rank of the ally character is raised to, for example, "RANK 2" (all of the "RANK 1" equipment items are treated as being equipped). At this time, if the character level has not reached the level required to equip the "RANK 1" equipment items, the character level is raised to the minimum level required to equip the equipment items (level 3 in this example).

Then, as illustrated in FIG. 13A, that the equipment rank has become RANK 2 is displayed on the ally character detail screen. Also, the obtainment method operation portion 37a is hidden in the enhance details display region 37. The nurture ball band 57 is displayed superimposed on the equipment operation portion 37b.

Further, the nurture ball band 57 is also displayed superimposed on the auto-enhance operation portion 38 and the rank-up operation portion 39. Then, when the equipment operation portion 37b on which the nurture ball band 57 is superimposed is tapped, the equipment item displayed in the enhance details display region 37 is equipped to the ally character without charge (without consuming an equipment item owned by the player). When the rank-up operation portion 39 on which the nurture ball band 57 is superimposed is tapped, the equipment rank is raised by 1 without charge. When the auto-enhance operation portion 38 on which the nurture ball band 57 is superimposed is tapped, the character level, the skill level, and the equipment rank of the ally character are raised as high as they can be increased without charge.

When the equipment rank is RANK 10 and all of the RANK 10 equipment items are equipped without charge, the free equipment completion pop-up 60 is displayed on the display 26 as illustrated in FIG. 13B. The free equipment completion pop-up 60 displays a text notifying the player that all of the equipable equipment items have been equipped without charge.

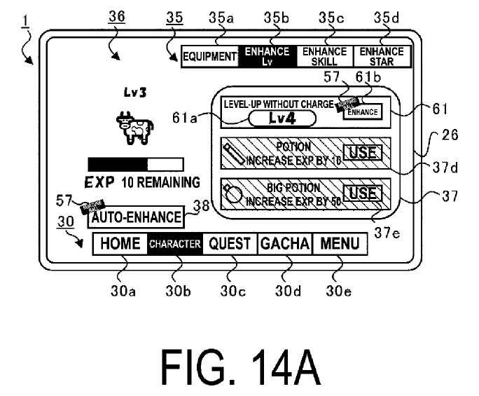

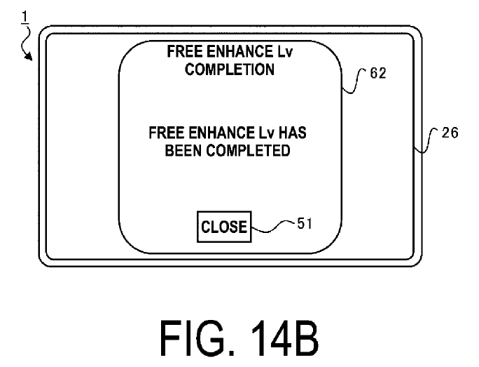

FIG. 14A is a second diagram for describing an example of an ally character detail screen after the player has come to own a nurture ball. FIG. 14B is a diagram for describing an example of the free enhance Lv completion pop-up 62.

When the enhance Lv selection operation portion 35b is tapped on the ally character detail screen illustrated in FIG. 13A, the ally character detail screen illustrated in FIG. 14A is displayed on the display 26. As illustrated in FIG. 14A, the free level-up display portion 61 is displayed above the item display portion 37d in the enhance details display region 37 of the ally character detail screen. The free level-up display portion 61 is provided with the pull-down type level selection operation portion 61a for selecting how much to raise the character level. The player operates the level selection operation portion 61a to select a desired character level. In the level selection operation portion 61a, the character levels that can be raised at the present time are displayed in a pull-down menu as candidates based on the player level and the character levels that can be raised with the used nurture ball.

Then, when the enhance operation portion 61b is tapped, the character level is raised to the character level displayed in the level selection operation portion 61a. Thereafter, when the character level becomes 100, the free enhance Lv completion pop-up 62 is displayed on the display 26 as illustrated in FIG. 14B. The free enhance Lv completion pop-up 62 displays a text notifying the player of the completion of raising the character level to the level that can be increased without charge. Until the character level of the ally character has been raised to the level that can be increased without charge, the use operation portion 37e of the item display portions 37d does not accept an operation by the player as indicated by hatching in the diagram.

The skill level can be raised to the same level as the character level without charge by using the nurture ball, but the way of raising the skill level is the same as that for the character level, and therefore, the description thereof is omitted.

When all the parameters associated with the nurture ball ID are increased without charge, the nurture ball ID is deleted from the ally character database.

FIG. 15 is a diagram for describing an example of a batch enhance screen. When the batch enhance screen selection operation portion 32 of the ally character confirmation screen of FIG. 9B is tapped, the batch enhance screen is displayed on the display 26. In the batch enhance screen, an image corresponding to an ally character able to raise at least one of the character level, the skill level, and the equipment rank from among ally characters corresponding to ally character IDs associated with the player ID is displayed. Note that the player can check all of the ally characters that are able to raise at least one of the character level, the skill level, and the equipment rank by performing a slide operation on the batch enhance screen.

Also, in the ally character database, when information indicating that the first synchro function or the second synchro function is usable is associated with the ally character ID, the synchro band 34 is displayed superimposed on the image of the ally character corresponding to the ally character ID, as illustrated in FIG. 15. Thus, that the first synchro function or the second synchro function is usable for the ally character on which the synchro band 34 is displayed is notified. The display mode of the synchro band 34 may be changed depending on whether only the first synchro function can be used, only the second synchro function can be used, or both the first synchro function and the second synchro function can be used.

As illustrated in FIG. 15, a confirm operation portion 70a and a cancel operation portion 70b are displayed on the batch enhance screen.

The player can select one or more ally characters by tapping the images of the ally characters in FIG. 15. Then, when the confirm operation portion 70a is operated in a state with one or more ally characters selected, the character level and the skill level are raised to the synchro level and the equipment rank is raised to the synchro rank if the synchro function is usable for the selected ally characters. On the other hand, if the synchro function is not usable for the selected ally characters, the character level, the skill level, and the equipment rank are raised as much as possible for a fee. In the present embodiment, when the character level of the ally character is raised using the first synchro function, the character level of the ally character cannot thereafter be returned to the character level of before the use of the first synchro function. However, when the character level of the ally character is raised using the first synchro function, the character level of the ally character may be able to be returned to the character level of before the use of the first synchro function.

As described above, in the information processing system S, it is possible to raise the character level or the equipment rank of all ally characters that have not reached the synchro level or the synchro rank from among ally characters owned by the player, within a range up to the synchro level or the synchro rank, based on an operation by the player, without charge. This makes it possible to reduce the possibility of an increase on the load on the player when the player tries to nurture many owned ally characters. Thus, the risk of the player becoming less motivated to play the game due to an increase in player load can be reduced.

Further, since the synchro function is used based on an operation by a player, it is possible to reduce the processing load on the player terminal 1 and the server 1000. Further, it is possible to raise the character level or the equipment rank to the character level or the equipment rank designated by the player within a range up to the synchro level or the synchro rank based on an operation by the player. That is, the character level or the equipment rank can be stopped at a predetermined value designated by the player without being raised to the synchro level or the synchro rank. In this manner, strategic performance in the game can be improved.

For example, in a case where the character level of the ally character is automatically synchronized to the synchro level, it is necessary to execute processing to also synchronize the character level of the ally character that is to be enhanced without charge to the synchro level every time the reference value of the synchro level is updated (increased). In a similar manner, in a case where the equipment rank of the ally character is automatically synchronized to the synchro rank, it is necessary to execute processing to also synchronize the equipment rank of the ally character that is to be enhanced without charge to the synchro rank every time the reference value of the synchro rank is updated (increased).

In the present embodiment, the character level and the equipment rank of the ally character to be enhanced to the synchro level and the synchro rank without charge are updated based on a player operation. This eliminates the need to execute the synchronization processing as described above every time the reference value of the synchro level or the synchro rank is updated (increased), and thus it is possible to reduce the processing load on the player terminal 1 and the server 1000.

In the case of a live service game, the types of ally characters that can be owned by a player tend to increase due to character releases accompanying the longer operation period. Thus, when the synchronization processing is to be executed, the number of ally characters to be synchronized becomes large, and there is a possibility that the processing load on the player terminal 1 and the server 1000 may increase. As described above, when the number of ally characters owned by the player becomes large, there is a possibility that the processing load will increase if the synchronization processing is automatically executed. However, according to the present embodiment, the character level and the equipment rank are updated based on a player operation, and thus it is possible to reduce the possibility of the processing load increasing when the character level and the equipment rank of all ally characters owned by the player are raised to the synchro level and the synchro rank.

Next, the basic configuration of the player terminal 1 and the server 1000 and communication processing will be described. Here, an example of basic communication processing of progressing the game and main communication processing related to the increase of parameters without charge will be described, and description of other processing will be omitted.

### Functional Configuration of Player Terminal 1

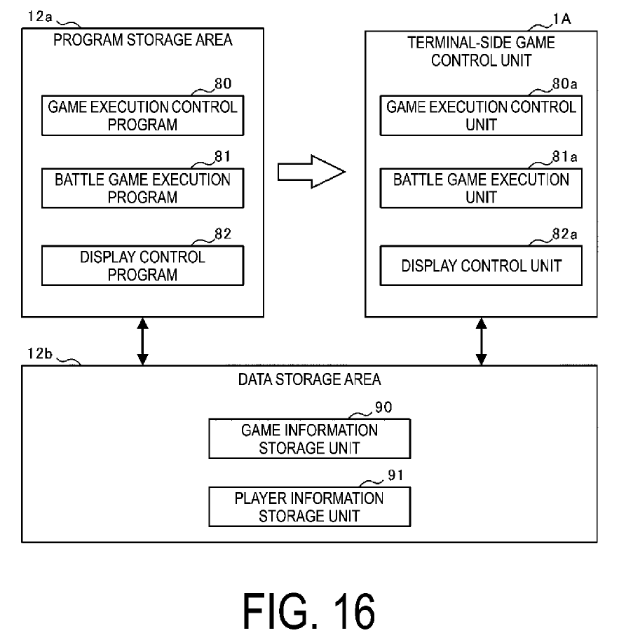

FIG. 16 is a diagram for describing a configuration of the storage device 12 in the player terminal 1 and a function thereof as a computer. The storage device 12 is provided with a program storage area 12a and a data storage area 12b. When the game is started, the CPU 10 stores a terminal-side game control program (module) in the program storage area 12a.

The terminal-side game control program includes a game execution control program 80, a battle game execution program 81, and a display control program 82. Note that the programs listed in FIG. 16 are examples, and many other programs are provided in the terminal-side game control program.

The data storage area 12b is provided with a game information storage unit 90 and a player information storage unit 91 as storage units for storing data. Note that the above-described storage units are merely examples, and many other storage units may be provided in the data storage area 12b.

The CPU 10 operates each program stored in the program storage area 12a and updates the data in each storage unit of the data storage area 12b. Then, the CPU 10 causes the player terminal 1 (computer) to function as a terminal-side game control unit 1A by running each program stored in the program storage area 12a. The terminal-side game control unit 1A includes a game execution control unit 80a, a battle game execution unit 81a, and a display control unit 82a.

Specifically, the CPU 10 runs the game execution control program 80 to cause the computer to function as the game execution control unit 80a. Similarly, the CPU 10 runs the battle game execution program 81 and the display control program 82 to cause them to function as the battle game execution unit 81a and the display control unit 82a, respectively.

The game execution control unit 80a controls the progress of the entire game. The game execution control unit 80a transmits login information to the server 1000, for example, at the time of login. The game execution control unit 80a performs control related to transition of the normal screen. When the game information of the entire game is updated, the game execution control unit 80a receives the game information from the server 1000 and stores it in the game information storage unit 90.

The battle game execution unit 81a is responsible for control to execute the battle game. For example, the battle game execution unit 81a updates the battle screen, controls the actions of the ally character and the enemy character, and derives the damage points based on the operation input to the player terminal 1.

The display control unit 82a generates a screen to be displayed on the display 26 and displays the generated screen on the display 26.

### Functional Configuration of Server 1000

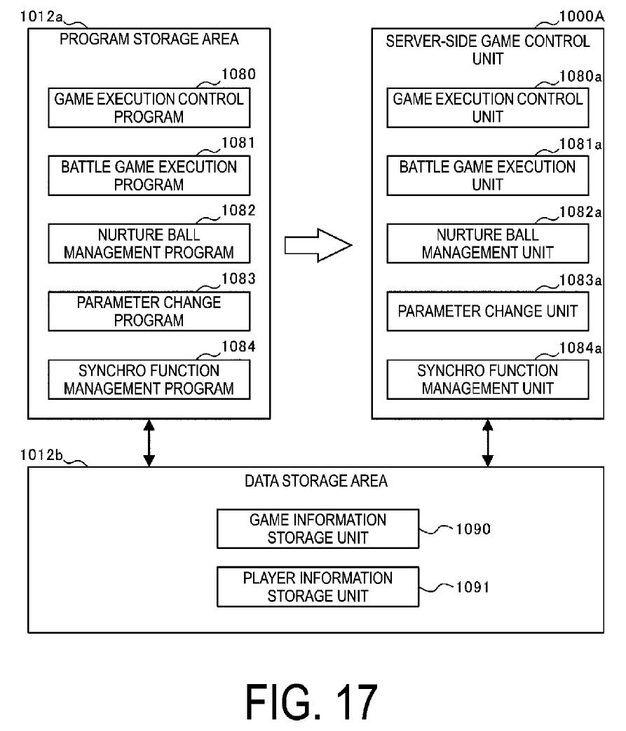

FIG. 17 is a diagram for describing the configuration of the storage device 1012 in the server 1000 and a function thereof as a computer. The storage device 1012 is provided with a program storage area 1012a and a data storage area 1012b. When the game is started, the CPU 1010 stores a server-side game control program (module) in the program storage area 1012a.

The server-side game control program includes a game execution control program 1080, a battle game execution program 1081, a nurture ball management program 1082, a parameter change program 1083, and a synchro function management program 1084. Note that the programs listed in FIG. 17 are examples, and many other programs are provided in the server-side game control program.

The data storage area 1012b is provided with a game information storage unit 1090 and a player information storage unit 1091 as storage units for storing data. Note that the respective storage units described above are merely examples, and many other storage units are provided in the data storage area 112b.

The CPU 1010 operates each program stored in the program storage area 1012a and updates the data in each storage unit of the data storage area 1012b. Then, the CPU 1010 causes the server 1000 to function as a server-side game control unit 1000A by running each program stored in the program storage area 1012a. The server-side game control unit 1000A includes a game execution control unit 1080a, a battle game execution unit 1081a, a nurture ball management unit 1082a, a parameter change unit 1083a, and a synchro function management unit 1084a.

Specifically, the CPU 1010 runs the game execution control program 1080 to cause the computer to function as the game execution control unit 1080a. Similarly, the CPU 1010 runs the battle game execution program 1081, the nurture ball management program 1082, the parameter change program 1083, and the synchro function management program 1084 and causes them to function as the battle game execution unit 1081a, the nurture ball management unit 1082a, the parameter change unit 1083a, and the synchro function management unit 1084a, respectively.

The game execution control unit 1080a controls the progress of the entire game. For example, upon receiving login information from the player terminal 1, the game execution control unit 1080a makes the player terminal 1 able to obtain the player information stored in the player information storage unit 1091. The player information includes the ally character database described above. When the game information of the entire game is updated, the game execution control unit 1080a reads out the updated game information from the game information storage unit 1090 and makes the player terminal 1 able to obtain it.

The battle game execution unit 1081a is responsible for control to execute the battle game.

When a nurture ball is used, the nurture ball management unit 1082a updates the ally character database and stores the nurture ball ID in association with the ally character ID of the ally character.

When an operation to change (raise) a parameter is performed via the ally character detail screen or the batch enhance screen, the parameter change unit 1083a changes (raises) the parameter in accordance with the operation.

The synchro function management unit 1084a determines the rank based on the value of the character level of the ally character owned by the player and sets the value of the character level corresponding to a predetermined rank (in the present embodiment, the top 30) as the synchro level. Then, the ally character database is updated, and information used as a reference value for the synchro level is stored in association with the ally character ID of the ally character of the set synchro level.

Further, the synchro function management unit 1084a updates the ally character database and stores information indicating that the first synchro function is usable in association with the ally character ID of the ally character whose character level is lower than the synchro level.

Also, the synchro function management unit 1084a determines the rank based on the value of the equipment rank of the ally character owned by the player and sets the value of the equipment rank corresponding to a predetermined rank (in the present embodiment, the top 30) as the synchro rank. Then, the ally character database is updated, and information used as a reference value for the synchro rank is stored in association with the ally character ID of the ally character of the set synchro rank.

Further, the synchro function management unit 1084a updates the ally character database and stores information indicating that the second synchro function is usable in association with the ally character ID of the ally character whose equipment rank is lower than the synchro rank.

Detailed Processing in Player Terminal 1 and Server 1000

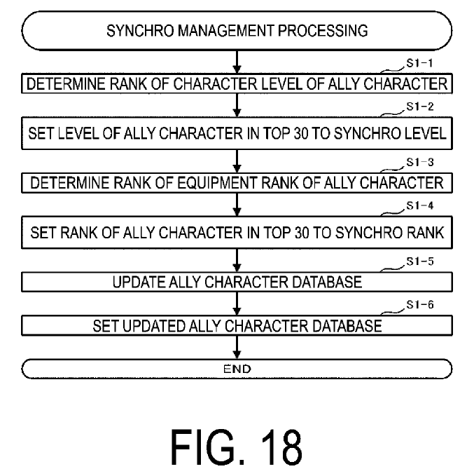

FIG. 18 is a flowchart for describing synchro management processing in the server 1000. The synchro management processing is executed in the server 1000 at a predetermined trigger set in advance. The predetermined trigger may be, for example, a timing at which the player starts a game application on the player terminal 1 and transmits login information to the server 1000. The predetermined trigger may be, for example, a timing at which the ally character confirmation screen is displayed on the player terminal 1. The predetermined trigger may be, for example, a timing at which the ally character detail screen is displayed on the player terminal 1. The predetermined trigger may be, for example, a timing at which the batch enhance screen is displayed on the player terminal 1. The predetermined trigger may be, for example, a timing at which a screen transition is performed on the player terminal 1.

When the synchro management processing is executed, the synchro function management unit 1084a determines the rank based on the value of the character level of the ally character owned by the player (S1-1). Then, the synchro function management unit 1084a sets the synchro level to the value of the character level corresponding to a predetermined rank (in the present embodiment, the top 30) among the determined ranks (S1-2).

Also, the synchro function management unit 1084a determines the rank based on the value of the equipment rank of the ally character owned by the player (S1-3). Then, the synchro function management unit 1084a sets the synchro rank to the value of the equipment rank corresponding to a predetermined rank (in the present embodiment, the top 30) among the determined ranks (S1-4).

The synchro function management unit 1084a updates the ally character database based on the setting contents of the step S1-2 and the step S1-4 described above and stores information on whether or not to use the reference value of the synchro level, information on whether or not to use the reference value of the synchro rank, and information on whether or not the synchro function is usable in association with each ally character ID (S1-5).

The synchro function management unit 1084a sets the ally character database updated in the step S1-5 described above so that the player terminal 1 can obtain the ally character database (S1-6).

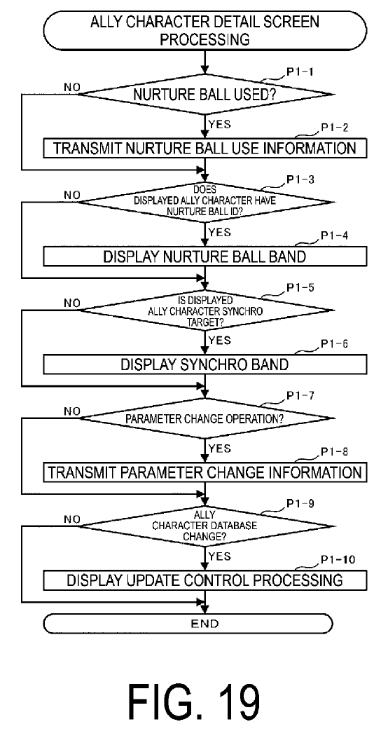

FIG. 19 is a flowchart for describing ally character detail screen processing in the player terminal 1. When the ally character detail screen processing is displayed on the display 26, the ally character detail screen processing illustrated in FIG. 19 is executed. In the ally character detail screen processing, when a nurture ball is used via the nurture ball list pop-up 55 illustrated in FIG. 12A, the equipment rank is determined via the rank-up confirmation pop-up 56 illustrated in FIG. 12B, and an operation of the confirm operation portion 56c is performed (YES in P1-1), the game execution control unit 80a transmits the nurture ball use information including the nurture ball ID associated with the used nurture ball, the ally character using the nurture ball, and the determined equipment rank to the server 1000 (P1-2).

When the nurture ball ID is associated with the ally character displayed on the ally character detail screen based on the ally character database (YES in P1-3), the display control unit 82a displays the ally character detail screen on which the nurture ball band 57 is displayed as illustrated in FIG. 13A and FIG. 14A on the display 26 (P1-4).

When the information indicating that the first synchro function or the second synchro function is usable is associated with the ally character displayed on the ally character detail screen based on the ally character database (YES in P1-5), the display control unit 82a displays the ally character detail screen on which the synchro band 34 is displayed as illustrated in FIG. 9B and FIG. 11A on the display 26 (P1-6).

When an operation to change a parameter is performed (YES in P1-7), the game execution control unit 80a transmits parameter change information indicating the parameter to be changed to the server 1000 (P1-8).

When the ally character database is changed (YES in P1-9), the display control unit 82a updates and displays the ally character detail screen, displays the free equipment completion pop-up 60 illustrated in FIG. 10B or FIG. 13B, or displays the free enhance Lv completion pop-up 62 illustrated in FIG. 11B or FIG. 14B, based on the changed ally character database (P1-10).

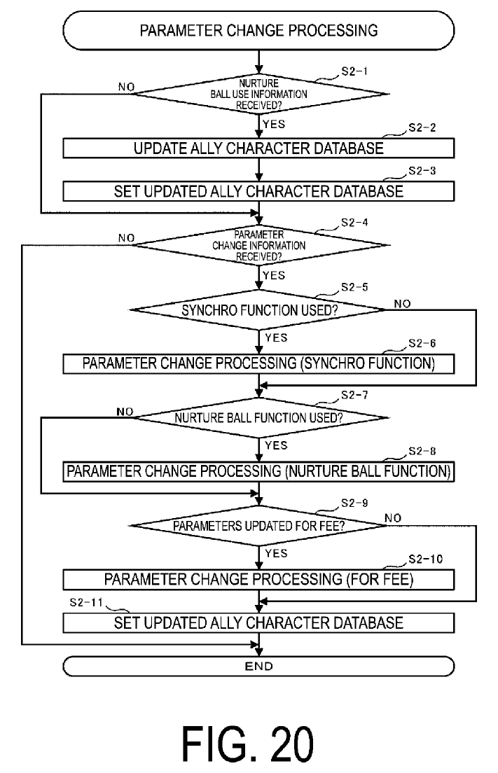

FIG. 20 is a flowchart for describing the parameter change processing in the server 1000. When the nurture ball use information is received (YES in S2-1), the nurture ball management unit 1082a stores the nurture ball ID in association with the ally character ID based on the nurture ball use information and updates the ally character database (S2-2). The nurture ball management unit 1082a sets the updated ally character database so that the player terminal 1 can obtain the ally character database (S2-3).

When the parameter change information is received (YES in S2-4) and the synchro function is used (YES in S2-5), the parameter change unit 1083a executes parameter change processing (S2-6) to change the parameter of the character level or the equipment rank of the ally character without charge and updates the ally character database. At this time, the parameter change unit 1083a changes the parameter of the character level or the equipment rank of the ally character without charge to the character level or the equipment rank designated by the player based on the received parameter change information. When the character level of the ally character has been raised to the synchro level without charge, the synchro function management unit 1084a deletes the information indicating that the first synchro function associated with the ally character ID is usable. When the equipment rank of the ally character has been raised to the synchro rank without charge, the synchro function management unit 1084a deletes the information indicating that the second synchro function associated with the ally character ID is usable.

When the nurture ball function is used (YES in S2-7), the parameter change unit 1083a executes parameter change processing (S2-8) to change the parameter of the character level or the equipment rank of the ally character without charge and updates the ally character database. At this time, the parameter change unit 1083a changes the parameter of the character level or the equipment rank of the ally character without charge to the character level or the equipment rank designated by the player based on the received parameter change information. When all the parameters associated with the nurture ball ID are increased without charge, the nurture ball management unit 1082a deletes the nurture ball ID from the ally character database.

When the synchro function and the nurture ball function are not used (YES in S2-9), the parameter change unit 1083a executes parameter change processing (S2-10) to change the parameter of the ally character for a fee and updates the ally character database. That is, the character level is raised by consuming items such as in-game currency and experience materials owned by the player. Alternatively, the equipment rank is raised by consuming items such as various equipment items and in-game currency owned by the player.

The parameter change unit 1083a sets the ally character database updated in the steps S2-6, S2-8, and S2-10 described above so that the player terminal 1 can obtain the ally character database (S2-11).

As described above, the player terminal 1 is provided with the game execution control program 80, the battle game execution program 81, and the display control program 82. The player terminal 1 functions as the game execution control unit 80a, the battle game execution unit 81a, and the display control unit 82a. Also, the server 1000 is provided with the game execution control program 1080, the battle game execution program 1081, the nurture ball management program 1082, the parameter change program 1083, and the synchro function management program 1084. The server 1000 functions as the game execution control unit 1080a, the battle game execution unit 1081a, the nurture ball management unit 1082a, the parameter change unit 1083a, and the synchro function management unit 1084a. However, one or more or all of these programs and functional units may be provided in one or both of the player terminal 1 and the server 1000.

The sharing of the processing executed in the player terminal 1 and the server 1000 in the embodiment described above is merely an example. For example, the above-described processes may be executed by at least one of the player terminal 1 and the server 1000 or by both of them, and the execution timing and the executing device are not particularly limited.

The processing of the player terminal 1 and the server 1000 in the embodiment described above is merely an example. It is needless to say that the processing in the player terminal 1 and the server 1000 can be designed as appropriate without departing from the object of the present invention.

Here, an aspect of the embodiment has been described with reference to the accompanying drawings. However, it goes without saying that the present invention is not limited to the above-described embodiment. It is apparent to those skilled in the art that various modifications and corrections can be made within the scope of the claims, and it should be understood that such modifications and corrections also obviously fall within the technical scope of the present invention.

### Processing Executed by Computer

Processing of determining a rank based on a value of a predetermined parameter (in the embodiment described above, for example, character level or equipment rank) associated with a game content owned by a player and of storing a value of the predetermined parameter corresponding to a predetermined rank as a reference value (in the embodiment described above, for example, synchro level or synchro rank) (in the embodiment described above, for example, step S1-2, step S1-4, and step S1-5).

Processing of enabling updating of the value of the predetermined parameter in accordance with a predetermined condition based on an operation by a player for the game content in which the value of the predetermined parameter with respect to the reference value satisfies a specific condition (in the embodiment described above, for example, being equal to or greater than the reference value) from among the game content owned by the player (in the embodiment described above, for example, step S2-9, step S2-10, and step S2-11).

Processing of enabling updating of the value of the predetermined parameter in accordance with an advantageous condition that is more advantageous to the player than the predetermined condition within a range up to the reference value based on an operation by a player for all of the game content in which the value of the predetermined parameter with respect to the reference value does not satisfy a specific condition (in the embodiment described above, for example, being less than the reference value) from among the game content owned by the player (in the embodiment described above, for example, step S2-5 to step S2-8 and step S2-11).

The predetermined condition may include consuming a consumable game content associated with the player.

The advantageous condition may include not consuming a consumable game content associated with the player. In the embodiment described above, a case where a consumable game content is not consumed is described as the advantageous condition, but the advantageous condition is not limited thereto. For example, as the advantageous condition, the consumption amount of the consumable game content may be reduced as compared with the predetermined condition. In addition, as an advantageous condition, another consumable game content having a lower difficulty to obtain than the consumable game content consumed under the predetermined condition may be consumed.

A computer may be caused to execute processing of determining a display mode of identification information corresponding to game content owned by a player based on whether or not a value of a predetermined parameter with respect to a reference value satisfies a specific condition (in the embodiment described above, for example, step P1-10).

The computer may be caused to execute processing of displaying a list of the identification information on the display screen in the determined display mode (in the embodiment described above, for example, step P1-10).

For the game content in a state where the value of the predetermined parameter is updated to the reference value according to the advantageous condition, the value of the predetermined parameter may be further updated based on the predetermined condition (in the embodiment described above, for example, step S2-9, step S2-10, and step S2-11).

In the embodiment described above, a case has been described in which, for each ally character ID, information indicating whether or not to use the reference value of the synchro level, information indicating whether or not to use the reference value of the synchro rank, information indicating whether or not to use the first synchro function, and information indicating whether or not to use the second synchro function are stored in association with the character database; however, these pieces of information need not be stored in association with the character database. For example, when the server 1000 side receives the parameter change information from the player terminal 1, the server 1000 side may refer to the character database to derive the synchro level and the synchro rank. Then, the server 1000 may update the character level of the ally character having a level lower than the synchro level without charge and update the character level of the ally character having a level equal to or higher than the synchro level for a fee. Also, the server 1000 may update the equipment rank of the ally character having a rank lower than the synchro rank without charge and update the equipment rank of the ally character having a rank equal to or higher than the synchro rank for a fee. The server 1000 may check whether there is a problem in the update content of the character level or the update content of the equipment rank and update the character level or the equipment rank if there is no problem. The server 1000 may check whether there is a problem in the update content of the character level or the update content of the equipment rank and not update the character level or the equipment rank when there is a problem.

The player terminal 1 may derive the synchro level and synchro rank by referring to the latest character database obtained from the server 1000. When the character database is updated in the server 1000, the player terminal 1 may obtain the updated character database and derive the synchro level and the synchro rank by referring to the latest character database obtained. Then, the player terminal 1 may display the ally character confirmation screen, the ally character detail screen, the batch enhance screen, and the like based on the derived synchro level and synchro rank. When the player performs an operation to change the character level of an ally character, the player terminal 1 may transmit, to the server 1000, parameter change information including information that enables identification of whether the character level of the ally character is less than the synchro level or equal to or greater than the synchro level. When the player performs an operation to change the equipment rank of an ally character, the player terminal 1 may transmit, to the server 1000, parameter change information including information that enables identification of whether the equipment rank of the ally character is less than the synchro rank or equal to or greater than the synchro rank.

In the embodiment described above, the character level can be raised by consuming items such as in-game currency and experience materials owned by the player. However, the character level may be raised based on experience accumulated by winning in the battle game.

In the embodiment described above, the rank is determined based on the value of the character level of the ally character owned by the player and the value of the character level corresponding to a predetermined rank (top 30) is set as the reference value of the synchro level, but no such limitation is intended. For example, the character level of the ally character having the lowest character level value from among the ally characters set in a predetermined frame by the player may be set as the reference value of the synchro level. Alternatively, the character level of any ally character designated by the player may be set as the reference value of the synchro level.

In the embodiment described above, the rank is determined based on the value of the equipment rank of the ally character owned by the player and the value of the equipment rank corresponding to a predetermined rank (top 30) is set as the reference value of the synchro rank, but no such limitation is intended. For example, the equipment rank of the ally character having the lowest equipment rank value from among the ally characters set in the predetermined frame by the player may be set as the reference value of the synchro rank. Alternatively, the equipment rank of any ally character designated by the player may be set as the reference value of the synchro rank.

In the embodiment described above, the synchro function is usable for the character level and the equipment rank, but the target that the synchro function can be used on is not limited to these. For example, the rank or rarity of the ally character may be the target of the synchro function. Further, the level or rank of a specific skill of the ally character may be the target of the synchro function. Also the target of the synchro function may be the number of weapons or armor that can be equipped to the ally character or the number of skills that can be obtained by the ally character. The level, rank, and rarity of equipment such as weapons and armor owned by the player may be the target of the synchro function. The level, rank, and rarity of the fusion material owned by the player may be the target of the synchro function.

In the embodiment described above, the synchro function is usable for all ally characters that do not satisfy the synchro level or the synchro rank from among the ally characters owned by the player, but there may be a restriction (for example, a maximum of 10 characters) placed on the number of ally characters that the synchro function can be used for. Alternatively, an item that enables the use of the synchro function may be provided, and the use of the synchro function may be permitted only to an ally character that has used the item.

In addition, an upper limit value of the character level may be set according to the type of ally character. Then, when the synchro level is higher than the upper limit value set for the character level, the character level may be changed without charge within a range of the upper limit value set for the character level by using the synchro function. Alternatively, when the synchro level is higher than the upper limit value set for the character level, the character level may be changed without charge within a range of the synchro level exceeding the upper limit value set for the character level by using the synchro function.

An information processing program for executing the processing according to the embodiment described above may be stored in a non-transitory computer-readable storage medium and provided as a non-transitory storage medium. Further, a player terminal or an information processing system including the storage medium may be provided. In addition, the above-described embodiment may be an information processing method for implementing the respective functions and the steps illustrated in the flowcharts.

What is claimed is:

1. A non-transitory computer readable medium storing a program causing a computer to execute processing of:
determining a rank based on a value of a predetermined parameter associated with game content owned by a player and storing the value of the predetermined parameter corresponding to a predetermined rank as a reference value;
enabling update of the value of the predetermined parameter in accordance with a predetermined condition based on a player operation for the game content, from among the game content owned by a player, for which the value of the predetermined parameter with respect to the reference value satisfies a specific condition; and
enabling update of the value of the predetermined parameter in accordance with an advantageous condition that is more advantageous to a player than the predetermined condition within a range up to the reference value based on a player operation for the game content, from among the game content owned by a player, for which the value of the predetermined parameter with respect to the reference value does not satisfy the specific condition.

2. The non-transitory computer readable medium according to claim 1, wherein
the predetermined condition includes a consumable game content associated with a player being consumed, and
the advantageous condition includes the consumable game content associated with a player not being consumed.

3. The non-transitory computer readable medium according to claim 1, wherein the program further causes a computer to execute processing of:
determining a display mode of identification information corresponding to the game content owned by a player, based on whether the value of the predetermined parameter with respect to the reference value satisfies the specific condition; and
displaying a list of the identification information on a display screen using the display mode determined.

4. The non-transitory computer readable medium according to claim 1, wherein
the value of the predetermined parameter is capable of further being updated based on the predetermined condition for the game content with the value of the predetermined parameter in a state of having been updated to the reference value via the advantageous condition.

5. An information processing method executed by one or more computers, the method comprising:
determining a rank based on a value of a predetermined parameter associated with game content owned by a player and storing the value of the predetermined parameter corresponding to a predetermined rank as a reference value;
enabling update of the value of the predetermined parameter in accordance with a predetermined condition based on a player operation for the game content, from among the game content owned by a player, for which the value of the predetermined parameter with respect to the reference value satisfies a specific condition; and
enabling update of the value of the predetermined parameter in accordance with an advantageous condition that is more advantageous to a player than the predetermined condition within a range up to the reference value based on a player operation for the game content, from among the game content owned by a player, for which the value of the predetermined parameter with respect to the reference value does not satisfy the specific condition.

6. An information processing system provided with one or more computers, wherein the one or more computers execute processing of:
determining a rank based on a value of a predetermined parameter associated with game content owned by a player and storing the value of the predetermined parameter corresponding to a predetermined rank as a reference value;
enabling update of the value of the predetermined parameter in accordance with a predetermined condition based on a player operation for the game content, from among the game content owned by a player, for which the value of the predetermined parameter with respect to the reference value satisfies a specific condition; and
enabling update of the value of the predetermined parameter in accordance with an advantageous condition that is more advantageous to a player than the predetermined condition within a range up to the reference value based on a player operation for the game content, from among the game content owned by a player, for which the value of the predetermined parameter with respect to the reference value does not satisfy the specific condition.
